(19) United States
(12) Patent Application Publication
(10) Pub. No.: US 2026/0119511 A1
(43) Pub. Date: Apr. 30, 2026

(54) Machine Learning Approach to Provide Search Results Grouped by Different Parameters

(71) Applicant: Maplebear Inc., San Francisco, CA (US)

(72) Inventors: Taesik Na, Issaquah, WA (US); Yuanzheng Zhu, Smyrna, GA (US); Prakash Putta, Seattle, WA (US); Nkemakonam Paulet Okoye, Bellevue, WA (US); Aomin Wu, Scarsdale, NY (US); Tejaswi Tenneti, San Carlos, CA (US); Shishir Kumar Prasad, Fremont, CA (US); Haixun Wang, Bellevue, WA (US)

(21) Appl. No.: 18/934,020

(22) Filed: Oct. 31, 2024

(51) Int. Cl. G06F 16/2457; G06F 16/9538

(52) U.S. Cl. CPC G06F 16/24578; G06F 16/9538

(57) ABSTRACT

An online system receives, at a search interface, a search term from a user. The system retrieves from a mapping table grouping parameters associated with the search term in the mapping table. The association between the grouping parameters and the search term in the mapping table is generated by generating a prompt including the search term and a set of physical objects that match the search term. The prompt requests grouping parameters for the set of physical objects, wherein each grouping parameter specifies a characteristic of the set of physical objects for providing search results responsive to the search term. The system receives, from the LLM, the grouping parameters and updates the mapping table. The system retrieves search results by querying a database of the online system using the search term. The system generates for display a user interface that groups the search results by the retrieved grouping parameters.

### BACKGROUND

Users are often unsuccessful in finding relevant search results when searching for desired physical objects to be ordered using broad search terms in online systems. This results in a series of iterative searches as the users refine their search query to narrow down results. Such a process is not only time-consuming for the users but also computationally inefficient, resulting in parsing through massive amounts of database entries on a recurring basis as brute force search query refinement is performed where the same database entries are repeatedly searched, and also resulting in consumption of unnecessary network bandwidth for searches whose results go unused. Each refined search query triggers new database lookups, many of which may be redundant. This inefficiency leads to increased network latency and computational waste for useless lookups.

### SUMMARY

An improved user interface with intelligent grouping parameters provides diverse search results from search queries. In some embodiments, multiple carousels with different grouping parameters are displayed, thus providing robust results that reduce the need to perform follow-up searches and provide efficient use of computational resources. For example, a search for a physical object (e.g., pasta) may provide diverse carousels grouped according to a first grouping parameter, a second grouping parameter, and/or a third grouping parameter (e.g., flour type, country of origin, and style of noodle). Search results grouped by different parameters may allow users to explore various aspects of their search query simultaneously, thus reducing follow-up searches and optimizing computational resource usage.

In accordance with one or more aspects of the disclosure, an online system receives, at a search interface, a search term from a user. The system retrieves, from a mapping table maintained by the online system, one or more grouping parameters associated with the search term in the mapping table. The association between the grouping parameters and the search term in the mapping table is generated by generating a prompt including the search term and a set of physical objects that match the search term. The prompt requests one or more candidate grouping parameters for the set of physical objects, wherein each candidate grouping parameter specifies a characteristic of the set of physical objects for providing search results responsive to the search term. The prompt is provided to a large language model (LLM). The system receives, from the LLM, the suggested grouping parameters and updates the mapping table with the association between the grouping parameters and the search term. The system retrieves a set of search results responsive to the search by querying a database of the online system using the search term. The system generates, for display, a user interface that groups the search results by the retrieved grouping parameters. The system causes a device associated with the user to display the generated user interface.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example system architecture for a search management module, in accordance with one or more embodiments.

FIG. 4 is a flowchart of a method for providing diverse search results, according to one or more embodiments.

FIG. 5 illustrates a simplified user interface of a carousel interface, according to one or more embodiments.

### DETAILED DESCRIPTION

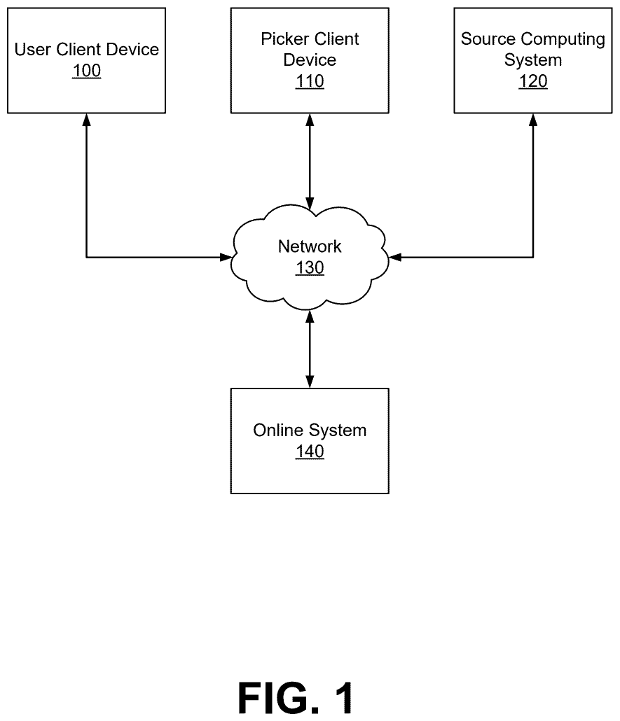

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the online system 140 or the source computing system 120. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, may be an example of a physical object. While the item is used as an example of the physical object in this disclosure, the physical object may also include other examples. The item may refer to a product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface may allow the user to search for items that are available through the online system 140 and the user can select which items to add to an “ordering list.” An “ordering list,” as used herein, is a tentative set of items that the user has selected for an order but that has not yet been finalized for an order. The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive recipes or item suggestions. The user client device 100 may present the received additional content to the user as the user uses the user client device 100 to place an order (e.g., as part of the ordering interface). The user client device 100 can include a communication interface that allows the user to communicate with a picker that is servicing the user's order. This communication interface may allow the user to input a text-based message to transmit to the picker client device 110 via the network 130.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140. The picker client device 110 may receive orders from the online system 140 for the picker to service. A picker may service an order by collecting the items listed in the order from a source when available. The picker client device 110 may present the items that are included in the user's order to the picker in a collection interface. The collection interface is a user interface that provides information to the picker on which items to collect for a user's order and the quantities of the items. The picker can use the picker client device 110 to keep track of the items that the picker has collected to ensure that the picker collects all the items for an order. When the picker has collected the items for an order, the picker client device 110 may instruct a picker on where to deliver the items for a user's order.

The source computing system 120 is a computing system operated by a source that interacts with the online system 140. As used herein, a “source” may be an entity that operates a “source location,” from which a picker can collect items. The source computing system 120 stores and provides item data to the online system 140 and may regularly update the online system 140 with updated item data. The source computing system 120 may provide the online system 140 with updated item prices, sales, or availabilities. The source computing system 120 may receive payment information from the online system 140 for orders serviced by the online system 140.

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all the of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 may receive orders from a user client device 100 through the network 130. The online system 140 may select a picker to service the user's order and transmit the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

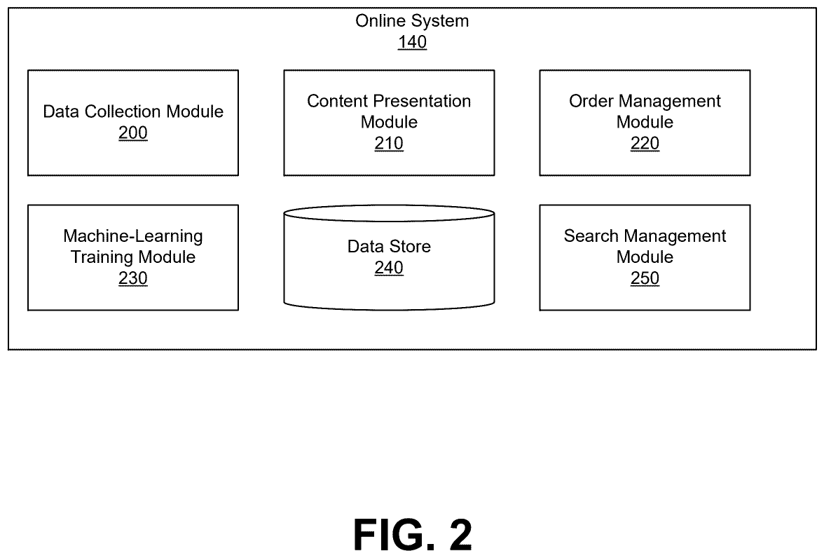

As an example, the online system 140 may allow a user to order physical objects from a source location. The user's order may specify which physical objects they want delivered from the source location and the quantities of each of the physical objects. The user's client device 100 transmits the user's order to the online system 140 and the online system 140 selects a picker to travel to the source location to collect the physical objects ordered by the user. The online system transmits an offer to the picker for the picker to service the order in exchange for consideration and, if the picker accepts the offer, the picker collects the physical objects from the source location. Once the picker has collected the physical objects ordered by the user, the picker delivers the physical objects to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, a data store 240, and a search management module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In the preferred embodiments, the data collection module 200 only collects data describing a user if the user has previously explicitly consented to the online system 140 collecting data describing the user. Additionally, the data collection module 200 may encrypt all data, including sensitive or personal data, describing users. For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect item data, which is information or data that identifies and describes items that are available at a source location. The item data may include item identifiers for items that are available and may include quantities of items associated with each item identifier. The data collection module 200 may collect picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history.

The data collection module 200 may collect order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 may generate and transmit an ordering interface for the user to order items. The content presentation module 210 may populate the ordering interface with items that the user may select for adding to their order. In some embodiments, the content presentation module 210 presents a catalog of all items that are available to the user, which the user can browse to select items to order. The content presentation module 210 may identify items that the user is most likely to order and present those items to the user. For example, the content presentation module 210 may score items and rank the items based on their scores. The content presentation module 210 may display the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

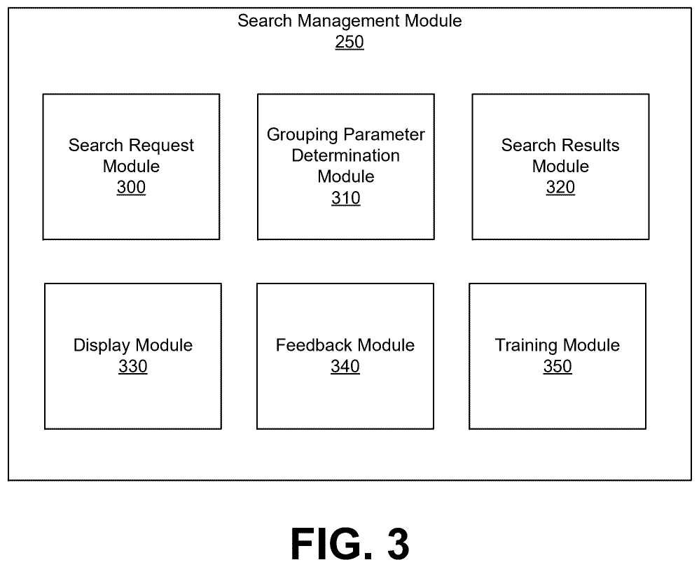

In some embodiments, the content presentation module 210 may display diverse search results to the user in response to a search query. In some embodiments, in response to the search query, the online system 140 may access a mapping table to retrieve one or more grouping parameters associated with the search term. Each grouping parameter may be a characteristic of a searched item. A grouping parameter may be used to categorize and organize search results. For beers, examples of grouping parameters may include beer style (e.g., IPA, lager, stout), alcohol content (e.g., low, medium, high), or flavor profile (e.g., hoppy, malty, fruity). The grouping parameter may not be static but dynamically generated using an LLM. This approach may provide for flexible and context-aware grouping of search results. Based on the grouping parameters, the content presentation module 210 can organize physical objects to provide search results grouped by different parameters to the user. In further embodiments, the content presentation module 210 can display the search results into multiple carousels, each one corresponding to a different grouping parameter. This multi-carousel approach yields search results grouped by different parameters, reducing a need for repeat searches. The above-mentioned features are further discussed in reference to FIG. 3.

The order management module 220 may manage orders for items from users. The order management module 220 may receive orders from a user client device 100 and offer the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

When the order management module 220 may offer an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 may track the location of the picker within the source location. The order management module 220 may use sensor data from the picker client device 110 or from sensors in the source location to determine the location of the picker in the source location. The order management module 220 may transmit to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 may determine when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 may transmit the delivery location for the order to the picker client device 110. The order management module 220 may also transmit navigation instructions to the picker client device 110 that specify how to travel from the source location to the delivery location, or to a subsequent source location for further item collection.

The order management module 220 may track the location of the picker as the picker travels to the delivery location for an order, and updates the user with the location of the picker so that the user can track the progress of the order.

In some embodiments, the order management module 220 may facilitate communication between the user client device 100 and the picker client device 110. As noted above, a user may use a user client device 100 to send a message to the picker client device 110. The order management module 220 may receive the message from the user client device 100 and transmits the message to the picker client device 110 for presentation to the picker. The picker may use the picker client device 110 to send a message to the user client device 100 in a similar manner.

The order management module 220 may coordinate payment by the user for the order. The order management module 220 may use payment information provided by the user (e.g., a credit card number or a bank account) to receive payment for the order. In some embodiments, the order management module 220 may store the payment information for use in subsequent orders by the user. The order management module 220 may compute the total cost for the order and charges the user that cost. The order management module 220 may provide a portion of the total cost to the picker for servicing the order, and another portion of the total cost to the source.

The machine-learning training module 230 can train machine-learning models used by the online system 140. The online system 140 may use machine-learning models to perform functionalities described herein. Example machine-learning models may include LLMs, regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models.

A machine-learning model may include components relating to these different general categories of model, which may be sequenced, layered, or otherwise combined in various configurations. While the term “machine-learning model” may be broadly used herein to refer to any kind of machine-learning model, the term may generally be limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model may include a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 may generate the set of parameters (e.g., the particular values of the parameters) for a machine-learning model by “training” the machine-learning model. Once trained, the machine-learning model uses the set of parameters to transform inputs into outputs.

The machine-learning training module 230 can train a machine-learning model based on a set of training examples. Each training example may include input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 may apply the machine-learning model to the input data in the training example to generate an output based on a current set of parameter values. The machine-learning training module 230 may score the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 may update the set of parameters for the machine-learning model based on the score generated by the loss function. For example, the machine-learning training module 230 may apply gradient descent to update the set of parameters.

In some embodiments, the machine-learning training module 230 may use an iterative process to train an LLM using a training dataset. The training dataset may include instances of search terms, sets of items matching those terms, and grouping parameters used for organizing search results. These instances may be derived from aggregated feedback data collected from user interactions with search results. The machine-learning training module 230 may input, into the LLM, a search term and its associated set of items from each training instance. The machine-learning training module 230 may prompt the LLM to generate one or more grouping parameters based on the inputs.

The machine-learning training module 230 may receive the grouping parameters generated by the LLM. The machine-learning training module 230 may compare the grouping parameters to known grouping parameters from the training dataset to calculate a loss function. The machine-learning training module 230 may adjust the variables of the LLM to reduce the loss provided by the loss function. The machine-learning training module 230 may repeat the training process across multiple batches of training instances to refine the LLM's ability to generate relevant grouping parameters. The machine-learning training module 230 may repeat the training process until a predetermined performance threshold is achieved or a maximum number or a predetermined of iterations is reached. These embodiments are further discussed in reference to FIG. 3.

The data store 240 may store data used by the online system 140. For example, the data store 240 may store user data, item data, order data, and picker data for use by the online system 140. The data store 240 may also store LLMs trained by the machine-learning training module 230. For example, the data store 240 may store the set of parameters for a trained LLM on one or more non-transitory, computer-readable media. The data store 240 may use computer-readable media to store data, and may use databases to organize the stored data.

The search management module 250 may provide diverse search results based on a user search query. Responsive to receiving a search term from the user, the search management module 250 may retrieve one or more grouping parameters associated with the search term from a mapping table. In some embodiments, the search management module 250 may construct a prompt including the search term and a set of relevant physical objects to input it into an LLM, which may dynamically generate the grouping parameters. Responsive to obtaining the grouping parameters from the LLM, the search management module 250 may use them to organize the search results. The search management module 250 may group search results based on grouping parameters to provide users with a diverse view of available options. These features may expose users to a broader range of relevant options they may not have initially considered. The search management module 250 is described below in greater details in reference to FIG. 3.

FIG. 3 illustrates an example system architecture for a search management module 250, in accordance with some embodiments. The system architecture illustrated in FIG. 3 includes a search request module 300, a grouping parameter determination module 310, a search results module 320, a display module 330, a feedback module 340, and a training module 350. Alternative embodiments may include more, fewer, or different components from those illustrated in FIG. 3, and the functionality of each component may be divided between the components differently from the description below.

In some embodiments, the search request module 300 may initiate the process responsive to receiving a user's search query. The search query is referred to as a search term entered by a user on a search interface on the user client device 100 to initiate a search for physical objects.

The search request module 300 may operate in conjunction with the content presentation module 210 of FIG. 2 to facilitate user searches. The content presentation module 210 may generate and present to a user the search interface on the user client device 100. The search interface can be a graphical component of the online system's user interface presented on the user client device 100. The search interface can include a text input field where users can enter one or more search terms to find physical objects available for delivery to a destination site specified by the user. A search term may be a word or set of words. For example, a user may be searching for a physical object such as “pasta” by entering the search term “pasta” into the text input field of the search interface.

Responsive to the user inputting a search term into the search interface on the user client device 100, the search request module 300 may receive the search term. In some embodiments, the search term may be annotated with auxiliary information derived from network communications or the user's client device, such as user ID, timestamp, device information, etc.

The search request module 300 may validate and/or format the search term for further processing. The search request module 300 may store the search term and/or associated metadata within the data store 240. The search request module 300 may provide the search term to the grouping parameter determination module 310 for further processing.

The grouping parameter determination module 310 may retrieve one or more grouping parameters responsive to the user search query. As used herein, the term “grouping parameter” may refer to a characteristic used to group different categories of search results. The grouping parameters may ensure diverse search results for physical objects. For example, in response to the search term “pasta,” the grouping parameter determination module 310 may determine a first grouping parameter, a second grouping parameter, and/or a third grouping parameter (e.g., flour type, country of origin, and style of noodle). Accordingly, the online system 140 may provide diverse carousels grouped according to the first grouping parameter, the second grouping parameter, and/or the third grouping parameter. By presenting grouped results based on grouping parameters, the online system 140 may reduce the need for follow-up searches, thereby optimizing computational resource usage. Users can explore various aspects of their search query simultaneously, which may provide a more efficient search experience. These features may minimize unnecessary database queries and network traffic, resulting in a more streamlined and efficient search process.

The grouping parameter determination module 310 may determine one or more grouping parameters responsive to the user search query through various approaches. In some embodiments, the grouping parameter determination module 310 may determine one or more grouping parameters by referencing a pre-existing mapping table that associates grouping parameters with search terms and/or physical objects responsive to the search terms. The use of a mapping table may offer significant technical improvements to the online system. When a mapping table is implemented, the system does not need to compute grouping parameters in real-time for every user search query. This architecture may reduce latency and computational complexity, leading to faster response times and a more efficient use of system resources. Moreover, this architecture may effectively offload complex computation from edge devices with constrained resources, such as mobile phones or tablets, to server-side systems such that resource-intensive tasks of determining grouping parameters may be performed in the background on the server infrastructure. The edge devices may simply need to reference the mapping table to retrieve the pre-computed grouping parameters, thus improving computational efficiency at the edge devices.

The mapping table may be a data structure that associates search terms or physical object identifiers with grouping parameters. The mapping table may be indexed by search terms or by physical object identifiers. The mapping table may be initially generated through historical search data analysis and user curation. In some embodiments, the grouping parameter determination module 310 may initially generate entries in the mapping table by associating grouping parameters with physical object identifiers or search terms. The grouping parameter determination module 310 may randomly select these initial grouping parameters to explore and experiment with different search results. Over time, the grouping parameter determination module 310 may update the mapping table with new grouping parameters. In some embodiments, the new grouping parameters may be based on historical search requests having the search term and resulting in user requests for delivery of physical objects. In some embodiments, the new grouping parameters may be generated by an LLM as explained in the present disclosure. In some embodiments, updates to the mapping table may occur when the LLM generates a grouping parameter that does not already exist in the mapping table for a given search term or physical object identifier. The mapping table may be stored in the data store 240 of the online system 140.

In some embodiments, in addition to or instead of using a mapping table, the grouping parameter determination module 310 may compute one or more grouping parameters on-the-fly responsive to receiving the search query. For example, the grouping parameter determination module 310 may compute the grouping parameters by prompting an LLM to provide one or more grouping parameters based on the search term (perhaps augmented with auxiliary information), as described in the present disclosure. This dynamic approach may provide flexibility and adaptability to the online system, especially for new or uncommon search queries.

The grouping parameter determination module 310 may generate a prompt to input into an LLM. The prompt may request, from the LLM, candidate grouping parameters for the set of physical object. The prompt may be a data structure that includes various elements organized in a pre-determined format. The prompt may include a template string with placeholders for dynamic content, the search term, physical objects that match the search term, instructions about the task, specifications for the desired output format and/or any relevant context data. For example, the prompt may be represented as a data structure (e.g., JavaScript object notation (JSON) object) as follows.

{
“template”: “As an AI assistant, your role involves using physical object data (including an
engagement score and historical search request data having the search term and resulting in a
request for delivery of the physical object) and their metadata for the search term
‘{search_term}’. Use this information to develop effective candidate grouping parameters for
grouping the {set_of_physical_objects_that_match_the_search_term} in a way that maximizes
search results grouped by different parameters for the physical objects on a search engine results
page (SERP). Provide {number_of_candidate_grouping_parameters} candidate grouping
parameters to group the {set_of_physical_objects_that_match_the_search_term}, accompanied
by reasoning for each suggestion. Use {output_format} format.”,
“search_term”: “[...]”,
“set_of_physical_objects_that_match_the_search_term”: [...],
“number_of_candidate_grouping_parameters”: 3,
“output_format”: “JSON”,
}

The data store 240 of the online system 140 may store the prompt template. To generate a prompt, the grouping parameter determination module 310 may retrieve the prompt template from the data store 240 and dynamically populate it by inserting relevant data into the template placeholders (e.g., ‘search_term’, ‘set_of_physical_objects_that_match_the_search_term’). The grouping parameter determination module 310 may source the relevant data for the placeholders from various components within the online system 140, primarily the data store 240, which contains relevant information about physical objects and their characteristics.

In some embodiments, the grouping parameter determination module 310 may select a set of physical objects that match the search term to input into the prompt through a multi-step process. The grouping parameter determination module 310 may determine a plurality of physical objects matching the search term by querying a database of physical objects in the data store 240 using the search term to retrieve relevant data associated with physical objects. This query process may include full-text search algorithms, semantic matching, or machine learning models to identify physical objects most relevant to the search term. The grouping parameter determination module 310 may group rank the retrieved physical objects based on an engagement score. The engagement score may be a numerical value representing the historical popularity and/or relevance of a physical object in relation to the given search term. The engagement score may be calculated using historical data, particularly focusing on past search requests that included the search term and resulted in delivery requests for corresponding physical objects. The grouping parameter determination module 310 may select a subset of the ranked physical objects, limited to a predetermined threshold number, to create a focused and relevant set of physical objects. The grouping parameter determination module 310 may store this set of physical objects in the data store 240. The set of physical objects that match the search term may include multiple data fields such as an object identifier, an object name, an engagement score, a description, and various other characteristics (or attributes). The object identifier field may indicate a unique ID for each physical object. The object name field may indicate the name of the physical object. The engagement score field may indicate the engagement score of the physical object. The description field may indicate a summary of the physical object's features or characteristics.

Responsive to the search term “Physical_Object_1,” the grouping parameter determination module 310 may select, according to the above process, a set of physical objects that match “Physical_Object_1” as

“Set_Of_Physical_Objects_That_Match_Physical_Object_1.” The grouping parameter determination module 310 may generate the following prompt: As an AI assistant, your role involves using physical object data (including an engagement score and historical search request data having the search term and resulting in a request for delivery of the physical object) and their metadata for the search term Physical_Object_1. Use this information to develop effective candidate grouping parameters for grouping the Set_Of_Physical_Objects_That_Match_Physical_Object_1 in a way that maximizes the search results grouped by different parameters for physical objects on a search engine results page (SERP). Provide 5 candidate grouping parameters to group the Set_Of_Physical_Objects_That_Match_Physical_Object_1, accompanied by reasoning for each suggestion. Use JSON format.

The grouping parameter determination module 310 may input the prompt into the LLM, which returns candidate grouping parameters. Responsive to the prompt input, the LLM may generate an output including candidate grouping parameters and associated data, which are received by the grouping parameter determination module 310. The grouping parameter determination module 310 may store the LLM output in the data store 240. The LLM output may include multiple data fields such as candidate grouping parameters, descriptions, physical object characteristics within each candidate grouping parameter, and physical objects associated with each characteristic. An example of the LLM output is provided in Table 1. As shown in Table 1, each candidate grouping parameter is accompanied by a description explaining how physical objects should be grouped based on that parameter. Within each candidate grouping parameter, there are multiple characteristics. For each of these characteristics, the output provides a list of physical objects that possess that specific characteristic.

For example, Candidate Grouping Parameter 1 groups physical objects based on characteristics such as Characteristic 1, Characteristic 2, and Characteristic 3. Under Characteristic 1, physical objects 1, 2, and 3 are listed, indicating that these objects share this particular characteristic within the broader grouping parameter. This structure may provide for a suitable organization of physical objects, providing multiple levels of categorization that can be used to create diverse search result groupings.

TABLE 1
Example of the LLM output

| | | Characteristics | |
|---|---|---|---|
| Candidate | | within the | |
| Grouping | | Candidate Grouping | Physical |
| Parameters | Description | Parameter | Objects |
| Candidate | Group Physical | Characteristic 1 | Physical Object 1, Physical Object 2, |
| Grouping | Objects based on | | Physical Object 3 |
| Parameter 1 | Candidate Grouping | Characteristic 2 | Physical Object 4, Physical Object 5, |
| | Parameter 1 such as | | Physical Object 6, Physical Object 7, |
| | Characteristic 1, | | Physical Object 8 |
| | Characteristic 2, and | Characteristic 3 | Physical Object 9, Physical Object 10, |
| | Characteristic 3 | | Physical Object 11, Physical Object 12 |
| Candidate | Group Physical | Characteristic 4 | Physical Object 4, Physical Object 12, |
| Grouping | Objects based on | | Physical Object 13, Physical Object 14, |
| Parameter 2 | Candidate Grouping | | Physical Object 7 |
| | Parameter 2 such as | Characteristic 5 | Physical Object 15, Physical Object 16, |
| | Characteristic 4, | | Physical Object 17 |
| | Characteristic 5, and | Characteristic 6 | Physical Object 9, Physical Object 18, |
| | Characteristic 6 | | Physical Object 2, Physical Object 19 |
| Candidate | Group Physical | Characteristic 7 | Physical Object 21, Physical Object 22, |
| Grouping | Objects based on | | Physical Object 23, Physical Object 24, |
| Parameter 3 | Candidate Grouping | | Physical Object 25 |
| | Parameter 3 such as | Characteristic 8 | Physical Object 1, Physical Object 6, |
| | Characteristic 7, | | Physical Object 26 |
| | Characteristic 8, and | Characteristic 9 | Physical Object 27, Physical Object 28, |
| | Characteristic 9 | | Physical Object 29, Physical Object 30 |

For example, for the search term “pasta,” the grouping parameter determination module 310 may generate a prompt and input it into the LLM, which returns relevant candidate grouping parameters. Table 2 illustrates an example of the output of the LLM, where each grouping parameter (flour type, country of origin, style of noodle) is associated with specific characteristics, and each characteristic is linked to specific pasta physical objects.

TABLE 2
Example of the LLM output

| Candidate | | Characteristics | |
|---|---|---|---|
| Grouping | | within the Candidate | Physical |
| Parameters | Description | Grouping Parameter | Objects |
| Flour | Group physical | Chickpea | Generic-Name Chickpea Rotini, |
| type | objects based on | Flour | Example-One Chickpea Casarecce, |
| | the type of flour | | Generic-Name Organic Chickpea Fusilli |
| | used in their | Whole | Generic-Name Whole Grain Spaghetti, |
| | production | Grain | Example-Two Whole Grain Penne, |
| | | | Generic-Name Whole Grain Rotini |
| | | Semolina | Generic-Name Semolina Penne Rigate, |
| | | | Generic-Name Semolina Farfalle, |
| | | | Example-One Semolina Rigatoni |
| Country of | Group physical | Italy | Example-Two Penne Rigate, Example- |
| origin | objects based on | | One Spaghetti, Generic-Name Rigatoni, |
| | their country of | | Example-One Fusilli, Generic-Name |
| | manufacture | | Spaghetti |
| | | USA | Generic-Name Lasagna, Generic-Name |
| | | | Chickpea Rotini, Example-One Organic |
| | | | Chickpea Penne |
| Style of | Group physical | Long, thin | Example-One Spaghetti, Example-Two |
| noodle | objects based on | noodles | Spaghetti, Generic-Name Whole Wheat |
| | their shape and | | Linguine |
| | form | Short, | Generic-Name Penne Rigate, Example- |
| | | tubular | Two Organic Chickpea Penne, |
| | | noodles | Example-One Whole Grain Penne |
| | | Spiral | Generic-Name Chickpea Rotini, |
| | | noodles | Generic-Name Organic Chickpea |
| | | | Fusilli, Generic-Name Harvest Whole |
| | | | Grain Rotini, Example-One Semolina |
| | | | Fusilli |

Based on the LLM output, the grouping parameter determination module 310 may select one or more grouping parameters among the candidate grouping parameters. In some embodiments, the selection of a grouping parameter may be specific to a source of the physical object. This selection process may provide for customization based on each source's unique needs and preferences. For example, this source-specific selection may include using predefined rules or weightings for different types of grouping parameters that align with the source's strategy, physical object catalog structure, or customer behavior patterns.

In some embodiments, the grouping parameter determination module 310 may select a grouping parameter among the candidate grouping parameters through a process of exploration and experimentation. Initially, the grouping parameter determination module 310 may randomly or systematically select each of the candidate grouping parameters for implementation. During this phase, the grouping parameter determination module 310 may monitor the performance of each selected grouping parameter by capturing its engagement score. The grouping parameter determination module 310 may store the engagement scores in the data store 204 for analysis. Once sufficient data has been collected on the engagement scores of candidate grouping parameters, the grouping parameter determination module 310 may use this information to make an informed selection. For example, the grouping parameter determination module 310 may select the candidate grouping parameter with the highest engagement score, compared to the engagement scores of other candidate grouping parameters, as this may indicate the most effective organization of search results. In some embodiments, when selecting N candidate grouping parameters, the grouping parameter determination module 310 may select the top N candidate grouping parameters with the highest engagement scores compared to the engagement scores of other candidate grouping parameters. After collecting engagement scores for candidate grouping parameters, the grouping parameter determination module 310 may train a machine learning model to predict engagement scores based on contextual data such as time of day, user demographics, or historical user behavior. The grouping parameter determination module 310 may use this trained machine learning model to make context-aware decisions about which grouping parameter to apply for a user query.

In some embodiments, the grouping parameter determination module 310 may select one or more grouping parameters from among the candidate grouping parameters through a process of entropy maximization. The entropy may be a measure of the evenness of distribution of engagement scores across the characteristic subgroups (e.g., Characteristic 1, Characteristic 2, Characteristic 3) within each candidate grouping parameter.

For each of these candidate grouping parameters, the grouping parameter determination module 310 may perform a series of calculations. The grouping parameter determination module 310 may group the set of search results based on the characteristic subgroups (e.g., Characteristic 1, Characteristic 2, Characteristic 3) defined by the candidate grouping parameter. The grouping parameter determination module 310 may calculate an engagement score for each characteristic subgroup. The grouping parameter determination module 310 may then calculate a proportion (p_i) of the engagement score for each characteristic subgroup relative to the total engagement score across all subgroups for that candidate grouping parameter. Using these proportions, the grouping parameter determination module 310 may calculate a characteristic information value for each subgroup using the formula-p_i*log (p_i). This value may represent the contribution of each subgroup to the overall entropy of the candidate grouping parameter. The grouping parameter determination module 310 may then sum these characteristic information values across all subgroups to obtain the entropy value for the entire candidate grouping parameter.

After calculating entropy values for all candidate grouping parameters, the grouping parameter determination module 310 may compare these values. It may select the candidate grouping parameter with the highest entropy value, compared to an entropy value for each other candidate grouping parameter associated with the search term, as the grouping parameter to be associated with the search term. This selection may provide that the chosen grouping parameter provides the most balanced distribution of engagement across its characteristic subgroups to offer users the most diverse engaging set of search results. In some embodiments, when selecting N grouping parameters, the grouping parameter determination module 310 may select the top N candidate grouping parameters with the highest entropy values.

Responsive to the selection of one or more grouping parameters, the grouping parameter determination module 310 may update the mapping table with new associations between the selected grouping parameters and the search term. This process may include adding or modifying entries in the mapping table, linking the search term to the selected grouping parameters. This update may provide that future searches using the same or similar terms can quickly access corresponding grouping parameters without repeating the entire selection process.

The search results module 320 may retrieve a set of search results responsive to the user's query by querying a database (e.g., data store 240) of the online system 140 using the search term. This process may be similar to the one undertaken by the grouping parameter determination module 310 when selecting the set of physical objects that match the search term. In fact, if the grouping parameter determination module 310 has already performed this step, the search results module 320 may simply retrieve the set of search results previously stored by the grouping parameter determination module 310 in the data store 240. This approach may avoid redundant database queries and use already processed data, potentially improving system efficiency. The retrieved set of search results includes relevant physical objects along with their associated metadata and engagement data.

In some embodiments, the search results module 320 may rank the search results into a list of ranked search results using the selected grouping parameters, while considering the user's profile and historical usage patterns. This ranking process may include organizing the search results within each characteristic subgroup of the grouping parameters, tailored to the individual user. The search results module 320 may consider factors such as relevance to the search term, engagement scores, physical object metadata, user profile information, historical user behavior, and contextual data. By ranking the results within each subgroup, the search results module 320 may provide that the most relevant or popular physical objects appear first within their respective categories. This approach may provide search results grouped by different parameters while also prioritizing the most relevant results for the user. The ranked list of search results may provide for a more structured and user-friendly presentation of the diverse set of physical objects, improving the user's ability to find desired physical objects efficiently.

In some embodiments, in response to the search term “pasta,” the search results module 320 may retrieve a set of search results for the search term “pasta” by querying the database of physical objects. For example, the search results may include various pasta-related physical objects such as “Example-One Spaghetti,” “Example-Two Penne Rigate,” “Generic-Name Lasagna,” and “Generic-Name Chickpea Rotini.” The search results module 320 may rank the search results within each grouping parameter (e.g., flour type, country of origin, and style of noodle) determined by the grouping parameter determination module 310. For instance, under the “flour type” grouping, the results may be ranked as: 1) Generic-Name Chickpea Rotini, 2) Generic-Name Whole Grain Spaghetti, 3) Generic-Name Semolina Penne Rigate. Under the “country of origin” grouping, the ranking might be: 1) Example-Two Penne Rigate (Italy), 2) Example-One Spaghetti (Italy), 3) Generic-Name Lasagna (USA). For the “style of noodle” grouping, the order could be: 1) Example-One Spaghetti, 2) Example-Two Penne Rigate, 3) Generic-Name Lasagna. The ranking within each grouping parameter may provide a diverse yet organized set of search results to the user.

The display module 330 may generate for display a user interface that groups the search results by the grouping parameter(s). For example, the display module 330 may operate in conjunction with the content presentation module 210 of the online system 140 to generate an ordering interface for display on the user client device 100, organizing the search results by the selected grouping parameter(s). The ordering interface may present the ranked search results in a structured format, with physical objects grouped according to the characteristics defined by each grouping parameter. The display module 330 may populate the ordering interface with the search results, ensuring that the physical objects within each group are displayed in their ranked order. By causing the user client device 100 to display this ordering interface, the display module 330 may provide users with a visually organized and diverse set of search results. This approach may allow users to easily navigate through different categories of results.

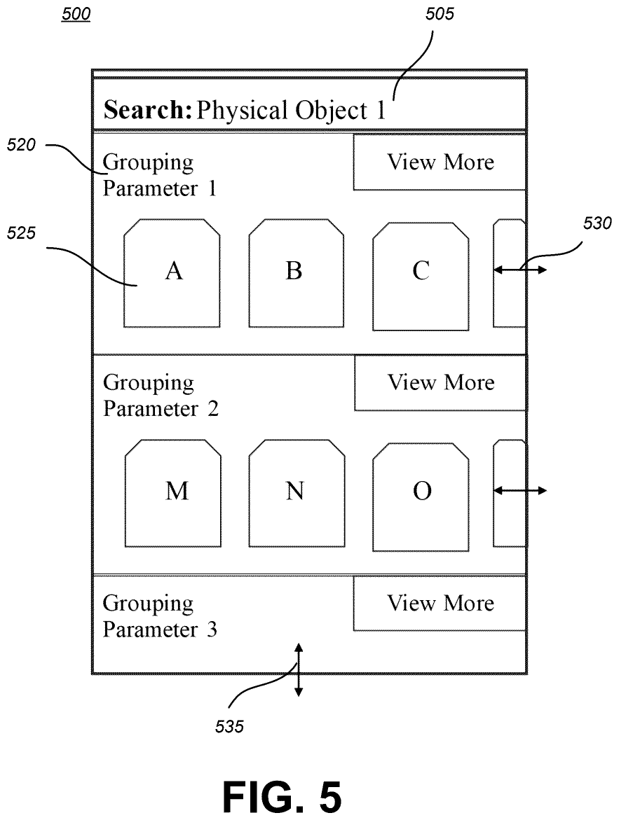

In some embodiments, the display module 330 in conjunction with the content presentation module 210 may generate an ordering interface having a carousel interface. The carousel interface may display the search results (e.g., physical objects) using one or more carousels, as further described below with reference to FIG. 5.

The display module 330 may generate multiple carousels on the ordering interface, each corresponding to a different candidate grouping parameter. For each candidate grouping parameter, the display module 330 may retrieve the set of search results by querying the system's database using the search term. The display module 330 may group these results based on the characteristics defined by the corresponding candidate grouping parameter. The display module 330 may generate a carousel for each grouped set of search results. Each carousel may display the search results organized according to its specific grouping parameter. For example, in response to the search term “pasta,” the display module 330 may generate a user interface that organizes the search results according to the determined grouping parameters. The display module 330 may create a separate carousel for each of the grouping parameters such as pasta flour types, countries of origin, and style of noodle. The carousels may be arranged on the user interface to allow easy navigation between different candidate grouping parameters. This approach may present users with various ways to explore the search results, each carousel offering a unique perspective on the available physical objects.

The feedback module 340 may collect and analyze feedback data with the presented search results. For example, the feedback module can collect feedback data after the search results have been presented to the user on a user interface. This feedback data may include various user actions, including user requests for delivery of physical objects from the search results. Such requests may be strong indicators of user interest and satisfaction with the search and grouping process. The feedback module 340 may track which physical objects users select for delivery, from which carousels or groupings these selections are made, and how users navigate between different grouping parameters. For example, as users interact with search results for “pasta” on the ordering interface, the feedback module 340 may collect data on their behavior, such as which pasta-related physical objects they click on or select for delivery.

In some embodiments, the feedback data may include various data fields such as user-related data (demographic data, search history, user preferences, etc.), click-through rates (which search results users click on within each grouping parameter), time spent (how long users engage with search results in different carousels or groupings), scroll depth (how far users scroll within each carousel and across multiple carousels), carousel switching (how frequently users switch between different grouping parameter carousel), repeat interactions (whether users consistently interact with certain types of grouping parameters across multiple search sessions), request for delivery of physical object (the rate at which interactions with specific grouping parameters lead to delivery requests), abandonment rates (how often users leave the search results page when presented with certain grouping parameters), filter usage (which filters users apply within specific grouping parameters), search refinement (how users modify their search queries after interacting with initial grouping parameters), session duration (the length of search sessions when different grouping parameters are presented), etc. By analyzing the feedback data over time, the online system may infer user preferences for specific types of grouping parameters. For example, a user who frequently engages with and requests for delivery physical objects from the “country of origin” grouping for pasta searches may be inferred to have a strong preference for this grouping parameter. Conversely, a user who consistently ignores physical objects from the “flour type” grouping may be inferred to find this grouping parameter less useful. The feedback data may be desired for assessing the effectiveness of different grouping parameter strategies and for refining the system's ability to present relevant and diverse search results. By capturing the feedback data, the online system 140 may continuously learn from user behavior, potentially improving the grouping parameters and search result presentations over time to better meet user needs and preferences.

The feedback module 340 may generate a training dataset by processing and aggregating feedback data from multiple instances of the same search term across various users and sessions. The aggregation may include synthesizing diverse user interaction data, including click-through rates, engagement times, scroll behaviors, and rates of request for delivery of physical objects. The feedback module 340 may associate the aggregated feedback data with the specific grouping parameters used to organize the search results, creating a multi-dimensional representation of user preferences and behaviors. For each search term, the feedback module 340 may create a training data instance. The training data instance may include the search term itself, the grouping parameter(s) applied, the set of physical objects that matched the search term, aggregated user interaction metrics for each grouping parameter, user demographic information (anonymized for privacy), and contextual data (such as time of search, device type, and location). This training data instance may capture the relationship between search terms, grouping parameters, physical objects, and user interactions. By storing these instances in a training dataset, the feedback module 340 may build a repository of information that reflects real-world user behavior and preferences.

The training module 350 may use the generated training dataset to train and fine-tune the LLM through an iterative process. For each training data instance, the training module 350 may input the search term, corresponding set of physical objects, and relevant user demographic and contextual information into the LLM. This may prompt the LLM to suggest a set of grouping parameters tailored to the specific search scenario and user profile. The training module 350 may compare the LLM's suggested grouping parameters with the ones recorded in the training data instance. This comparison may consider not just the grouping parameters themselves, but also their effectiveness in terms of user engagement metrics, requests for delivery of physical objects, and overall user satisfaction. Based on this comparison, the training module 350 may calculate a loss function that quantifies the discrepancy between the LLM's suggestions and the known effective grouping parameters across various dimensions of user interaction and preference. The training module 350 may adjust the LLM's variables to minimize this loss function, gradually improving the model's ability to suggest relevant grouping parameters.

The training process may be repeated across multiple instances and iterations until the LLM reaches a predetermined performance threshold or a maximum (or predetermined) number of iterations. The predetermined number of iterations may be 5, 10, 50, or 1000. In some embodiments, the predetermined number of iterations may be any number between 1 and 1 million. Through this approach, the training module 350 may refine the LLM's ability to generate effective grouping parameters, leading to more diverse search results for users over time.

In some embodiments, the training module 350 may train the LLM to predict optimal grouping parameters and/or rank carousels based on user preferences. Inputs to the LLM may include search terms, user profile information, and contextual data. The LLM may output either a ranked list of grouping parameters or a single preferred carousel. The LLM may be trained on feedback data including historical user interaction data. By using this predictive model, the system may bypass the LLM for frequent queries or users with well-established preferences, reducing latency and computational load. In some embodiments, the LLM may dynamically decide whether to present multiple ranked carousels or a single optimized carousel based on user's preferences and search context. This implementation may tailor search experiences to users while optimizing resource utilization.

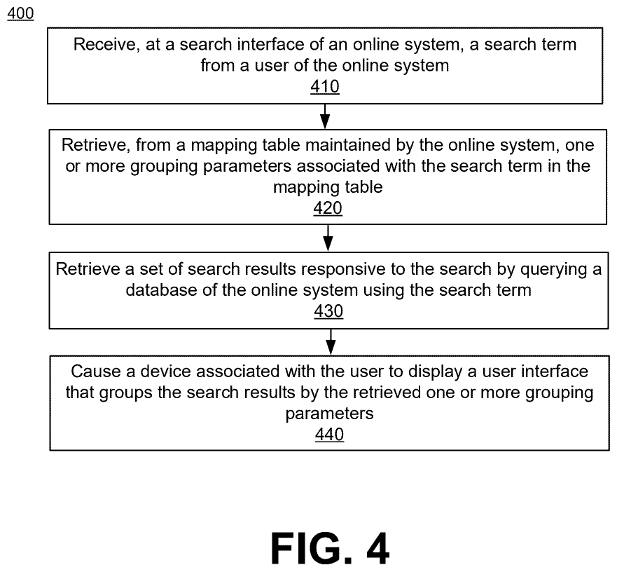

FIG. 4 is a flowchart depicting an example process 400 for providing diverse search results, in accordance with some embodiments. Some steps of the process 400 may be performed by one or more modules of the search management module 250 illustrated in FIG. 3. The process 400 may be embodied as a software algorithm that may be stored as computer instructions that are executable by one or more processors. The instructions, when executed by the processors, cause the processors to perform various steps in the process 400. In various embodiments, the process 400 may include additional, fewer, or different steps.

Process 400 begins with the search management module 250 receiving 410, at a search interface of an online system, a search term from a user of the online system (e.g., using the search request module 300). The search management module 250 then retrieves 420, from a mapping table maintained by the online system, one or more grouping parameters associated with the search term in the mapping table (e.g., using the grouping parameter determination module 310). The search management module 250 also retrieves 430 a set of search results by querying, using the search term, a database of the online system (e.g., using the search results module 320) The search management module 250 causes 440 a device (e.g., client user client device 100) associated with the user to display a user interface that groups the search results by the retrieved grouping parameters (e.g., using the display module 330).

FIG. 5 illustrates a simplified user interface of a carousel interface 500, generated by the display module 330 for display on a client device 100. The carousel interface 500 includes multiple carousels, each representing a different grouping parameter for search results. The carousel interface 500 includes a search bar 505 where users can input queries, with the current search term “Physical Object 1” displayed. Below the search bar, carousels such as “Grouping Parameter 1” 520 are presented, each containing a set of relevant physical objects like physical object 525. The carousels are designed to be horizontally scrollable (indicated by arrow 530), allowing users to browse through more physical objects within each grouping. The entire list of carousels is vertically scrollable (indicated by arrow 535), enabling users to explore carousels with different grouping parameters. This layout may provide a visually organized and interactive way for users to explore diverse search results, with each carousel offering a unique perspective on the available physical objects based on different grouping parameters.

In some embodiments, for the search term “pasta,” the carousel interface 500 may display multiple horizontally scrollable carousels, each representing a different grouping parameter such as “flour type,” “country of origin,” and “style of noodle.” These carousels may be vertically arranged and scrollable to allow users to explore different grouping arrangements. Within each carousel, pasta-related physical objects may be ranked based on personalized factors, including the user's profile and historical behavior. For example, the “flour type” carousel may display a physical object corresponding to “Banza Chickpea Rotini” first if the user has shown a preference for this particular physical object and a related option. Similarly, the “country of origin” and “style of noodle” carousels may reflect the user's preferences by prioritizing a physical object frequently selected and requested for delivery. This personalized ranking within each carousel may provide the most relevant options to the user while maintaining a diverse selection of pasta-related physical objects across different grouping parameters.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A computer-implemented method, comprising:
receiving, at a search interface of an online system, a search term to perform a search from a user of the online system;
retrieving, from a mapping table maintained by the online system, a plurality of grouping parameters associated with the search term in the mapping table, wherein an association between the plurality of grouping parameters and the search term in the mapping table is generated by:
generating a prompt, the prompt comprising the search term and a set of physical objects that match the search term, the prompt further requesting one or more candidate grouping parameters for the set of physical objects, wherein each candidate grouping parameter specifies a characteristic of the set of physical objects for providing search results responsive to the search term;
providing the prompt to a large language model (LLM);
receiving, from the LLM, the plurality of grouping parameters; and
updating the mapping table with the association between the plurality of grouping parameters and the search term;
retrieving a set of search results responsive to the search by querying a database of the online system using the search term; and
causing a device associated with the user to display a user interface that groups the search results by each of the plurality of grouping parameters, wherein the user interface includes a simultaneous display of a plurality of carousels, each carousel of the plurality of carousels horizontally scrollable and each carousel of the plurality of carousels corresponding to a given grouping parameter of the plurality of grouping parameters.

2. The computer-implemented method of claim 1, wherein the set of physical objects is selected by:
identifying a plurality of physical objects that match the search term;
ranking the plurality of physical objects based on an engagement score; and
selecting the plurality of physical objects to be up to a threshold number of physical objects of the plurality of physical objects as ranked based on the engagement score.

3. The computer-implemented method of claim 2, wherein the engagement score is generated based on historical search requests having the search term and resulting in a request for delivery of a physical object.

4. The computer-implemented method of claim 1, further comprising:
after causing the device associated with the user to display the user interface, collecting feedback data associated with user interaction with the search results.

5. The computer-implemented method of claim 4, wherein the feedback data comprises a user request for delivery of a physical object in the search results.

6. The computer-implemented method of claim 5, further comprising generating a training dataset based on the feedback data by:
aggregating the feedback data for multiple instances of the search term;
associating the aggregated feedback data with the grouping parameters used for grouping the search results;
based on the associating, generating a training data instance comprising the search term,
the grouping parameters used for grouping the search results associated with the search term, and
the set of physical objects that match the search term; and
storing the training data instance in the training dataset.

7. The computer-implemented method of claim 6, further comprising training the LLM using the training dataset by:
accessing training data instances from the training dataset;
for each training data instance of a batch of the training data instances:
inputting, into the LLM, the search term and the set of physical objects that match the search term,
prompting the LLM to suggest one or more grouping parameters for grouping the set of physical objects for the search term,
receiving, from the LLM, suggested one or more grouping parameters, and
comparing the suggested one or more grouping parameters with corresponding grouping parameters in the training data instance;
calculating a loss function based on the comparison of the grouping parameters suggested by the LLM and of the training data instances;
adjusting variables of the LLM to minimize the loss function; and
repeating the training of the LLM until a predetermined performance threshold is met or a predetermined number of iterations is reached.

8. The computer-implemented method of claim 1, further comprising ranking the search results into a list of ranked search results using the one or more grouping parameters.

9. The computer-implemented method of claim 8, further comprising generating for display the ranked search results to the user, the generating causing a device associated with the user to display the ranked search results.

10. (canceled)

11. The computer-implemented method of claim 1, wherein the prompt requests a candidate grouping parameter as part of a request for multiple candidate grouping parameters and wherein retrieving the grouping parameters associated with the search term comprises:
receiving, from the LLM, a plurality of candidate grouping parameters;
grouping the set of search results based on characteristic subgroups of the plurality of candidate grouping parameters,
calculating an engagement score for each characteristic subgroup within the grouped search results,
calculating a proportion of the engagement score for each characteristic subgroup relative to a sum of the engagement scores across all characteristic subgroups,
for each characteristic subgroup, calculating a characteristic information value based on the proportion of the engagement score,
calculating an entropy value for each candidate grouping parameter by summing the characteristic information values across all characteristic subgroups; and
responsive to comparing the entropy values of the plurality of candidate grouping parameters, selecting the candidate grouping parameter with a highest entropy value as compared to an entropy value for each other candidate grouping parameter associated with the search term.

12. A non-transitory computer-readable medium comprising memory with instructions encoded thereon, the instructions causing one or more processors to perform operations when executed, the instructions comprising instructions to:
receive, at a search interface of an online system, a search term to perform a search from a user of the online system;
retrieve, from a mapping table maintained by the online system, a plurality of grouping parameters associated with the search term in the mapping table, wherein an association between the plurality of grouping parameters and the search term in the mapping table is generated by:
generating a prompt, the prompt comprising the search term and a set of physical objects that match the search term, the prompt further requesting one or more candidate grouping parameters for the set of physical objects, wherein each candidate grouping parameter specifies a characteristic of the set of physical objects for providing search results responsive to the search term;
providing the prompt to a large language model (LLM),
receiving, from the LLM, the plurality of grouping parameters, and
updating the mapping table with the association between the plurality of grouping parameters and the search term;
retrieve a set of search results responsive to the search by querying a database of the online system using the search term; and
cause a device associated with the user to display a user interface that groups the search results by each of the plurality of grouping parameters, wherein the user interface includes a simultaneous display of a plurality of carousels, each carousel of the plurality of carousels horizontally scrollable and each carousel of the plurality of carousels corresponding to a given grouping parameter of the plurality of grouping parameters.

13. The non-transitory computer-readable medium of claim 12, wherein the set of physical objects is selected by:
determining a plurality of physical objects that match the search term;
ranking the plurality of physical objects based on an engagement score; and
selecting the plurality of physical objects to be up to a threshold number of physical objects of the plurality of physical objects as ranked based on the engagement score.

14. The non-transitory computer-readable medium of claim 13, wherein the engagement score is determined based on historical search requests having the search term and resulting in a request for delivery of a physical object.

15. The non-transitory computer-readable medium of claim 12, further comprising instructions to:
after causing the device associated with the user to display the user interface, collect feedback data associated with user interaction with the search results.

16. The non-transitory computer-readable medium of claim 15, wherein the feedback data comprises a user request for delivery of a physical object in the search results.

17. The non-transitory computer-readable medium of claim 16, further comprising instructions to:
aggregate the feedback data for multiple instances of the search term;
associate the aggregated feedback data with the grouping parameters used for grouping the search results;
based on the associating, generate a training data instance comprising the search term,
the grouping parameters used for grouping the search results associated with the search term, and
the set of physical objects that match the search term; and
store the training data instance in a training dataset.

18. The non-transitory computer-readable medium of claim 17, further comprising instructions to:
access training data instances from the training dataset;
for each training data instance of a batch of the training data instances:
input, into the LLM, the search term and the set of physical objects that match the search term,
prompt the LLM to suggest one or more grouping parameters for grouping the set of physical objects for the search term,
receive, from the LLM, suggested one or more grouping parameters, and
compare the suggested one or more grouping parameters with corresponding grouping parameters in the training data instance;
calculate a loss function based on the comparison of the grouping parameters suggested by the LLM and of the training data instances;
adjust variables of the LLM to minimize the loss function; and
repeat the training of the LLM until a predetermined performance threshold is met or a predetermined number of iterations is reached.

19. The non-transitory computer-readable medium of claim 12, further comprising instructions to rank the search results into a list of ranked search results using the one or more grouping parameters.

20. A computer system comprising:
one or more processors; and
a non-transitory computer readable storage medium storing instructions that, when executed by the one or more processors, cause the one or more processors to perform operations comprising:
receiving, at a search interface of an online system, a search term to perform a search from a user of the online system;
retrieving, from a mapping table maintained by the online system, a plurality of grouping parameters associated with the search term in the mapping table, wherein an association between the plurality of grouping parameters and the search term in the mapping table is generated by:
generating a prompt, the prompt comprising the search term and a set of physical objects that match the search term, the prompt further requesting one or more candidate grouping parameter for the set of physical objects, wherein each candidate grouping parameter specifies a characteristic of the set of physical objects for providing search results responsive to the search term;
providing the prompt to a large language model (LLM);
receiving, from the LLM, the plurality of grouping parameters; and
updating the mapping table with the association between the plurality of candidate grouping parameters and the search term;
retrieving a set of search results responsive to the search by querying a database of the online system using the search term; and
causing a device associated with the user to display a user interface that groups the search results by each of the plurality of grouping parameters, wherein the user interface includes a simultaneous display of a plurality of carousels, each of the carousels of the plurality of carousels horizontally scrollable and each carousel of the plurality of carousels corresponding to a given grouping parameter of the plurality of grouping parameters.
